(19) United States
(12) Patent Application Publication
(10) Pub. No.: US 2018/0104865 A1
(43) Pub. Date: Apr. 19, 2018

(54) METHOD AND APPARATUS FOR MANUFACTURING A FIBER-REINFORCED THERMOSET COMPOSITE

(71) Applicants: HYUNDAI MOTOR COMPANY, Seoul (KR); KIA MOTORS CORPORATION, Seoul (KR); Hyundai Motor Europe Technical Center GmbH, Russelscheim (DE)

(72) Inventors: Hermann HANSEN, Mainz (DE); Stephane RINGENBACH, Frankfurt am Main (DE); Julien RICHETON, Frankfurt am Main (DE)

(21) Appl. No.: 15/846,530

(22) Filed: Dec. 19, 2017

Related U.S. Application Data
(62) Division of application No. 14/542,255, filed on Nov. 14, 2014.

(30) Foreign Application Priority Data
Feb. 10, 2014 (DE) 10 2014 202 352.1

(51) Int. Cl. B29C 35/08; B29C 35/10; B29C 70/52; B29L 31/00

(52) U.S. Cl. CPC B29C 35/08; B29C 35/10; B29C 70/521; B29C 70/525; B29C 2035/0855; B29L 2031/707; B29C 35/0805

(57) ABSTRACT

A method of manufacturing a fiber-reinforced thermoset composite includes pulling a first portion of a continuous material comprised of reinforcement fibers which are impregnated with a heat curable thermosetting resin through a die. The first portion in the die is subjected to a field of electromagnetic microwaves to heat the first portion to at least a curing temperature of the thermosetting resin. A second portion of the continuous material is pulled through the die. The field of electromagnetic microwaves is reduced in the die such that the second portion is not heated to the curing temperature.

### CROSS-REFERENCE TO RELATED APPLICATIONS

This application is a divisional of U.S. patent application Ser. No. 14/542,255, filed Nov. 14, 2014, which claims the benefit of priority to German Patent Application No. 102014202352.1, filed on Feb. 10, 2014, the disclosures of which are incorporated herein by reference in their entirety.

### TECHNICAL FIELD

The present disclosure relates to a method and an apparatus for manufacturing a fiber-reinforced thermoset composite, and more particularly to a method and an apparatus for manufacturing multi-curve fiber-reinforced thermoset composites by using a pultrusion process.

### BACKGROUND

In the field of automobile construction, a variety of structural parts having multiple curves are commonly employed, such as, cowl cross bars, stabilizer bars, and coil springs. Conventionally, such parts are manufactured using steel shaped in a tube or coiled wire as a base material by a complex but well-manageable process which involves steps such as cold bending or drawing, quenching, and coating for corrosion protection. Since such steel based manufactured parts are main factors for the overall weight of an automobile, a significant reduction in the overall weight and the energy consumption of the automobile can be expected by substituting the steel with a material having similar strength with a lower weight, such as a fiber-reinforced plastic composite.

However, due to material property differences, processes used in manufacturing multi-curve shaped parts using steel cannot in general be used for fiber-reinforced composites. There is a method available for manufacturing general fiber-reinforced composite parts, especially thermoset composites, known as pultrusion, in which reinforcement materials, such as fibers, woven, or braided strands, are impregnated with a resin and pulled through a heated stationary die, and the resin undergoes polymerization. However, due to geometric difficulties, only straight or single curved shapes can be molded in the pultrusion die, such that the manufacturing of multi-curve shaped parts is impossible using the thermoset composites which need to be cured in the pultrusion die to obtain a desired shape.

EP0802851 B1 discloses a process comprising steps of pulling a reinforcing material impregnated with a heat curable thermosetting polymeric composition through a temperature controllable pultrusion die. The temperature of the pultrusion die and a drawing speed of the material are controlled, so that a predetermined length of material in the pultrusion die is substantially cured. The temperature of the pultrusion die is lowered, so that the predetermined length of the material which passes through the pultrusion die substantially remains being uncured. The uncured portion of the material emerging from the pultrusion die is reshaped, and the reshaped portion is cured. The pultrusion die is repeatedly heated and cooled, thus increasing energy consumption and limiting the speed during manufacturing. In particular, in order to provide a sharp transition between the cured and uncured portions, the step of pulling the material through the pultrusion die has to be discontinued or performed at a very slow rate while the die is being cooled.

### SUMMARY

The present disclosure provides a method of manufacturing a fiber-reinforced thermoset composite and an apparatus for manufacturing the same.

According to an embodiment of the present disclosure, a method of manufacturing a fiber-reinforced thermoset composite includes pulling a first portion of a continuous material comprised of reinforcement fibers which are impregnated with a heat curable thermosetting resin through a die. The first portion in the die is subjected to a field of electromagnetic microwaves to heat the first portion to at least a curing temperature of the thermosetting resin. A second portion of the continuous material is pulled through the die. The field of electromagnetic microwaves in the die is reduced such that the second portion is not heated to the curing temperature.

The field of electromagnetic microwaves is terminated in the step of reducing the field of electromagnetic microwaves.

The step of pulling the first portion and the step of pulling the second portion are performed by continuously pulling the continuous material through the die.

The method further comprises reshaping the second portion of the continuous material, and heating the second portion to at least the curing temperature of the thermosetting resin.

The step of reshaping is performed continuously.

The step of reshaping includes guiding the continuous material between a plurality of pulleys, and moving at least one of the pulleys in a reshaping direction perpendicular to a longitudinal direction of the continuous material.

The step of reshaping is performed by stamping at least the second portion of the continuous material in a stamping press.

The step of heating the second portion is performed concurrently with the step of reshaping the second portion.

According to another exemplary embodiment of the present disclosure, an apparatus for manufacturing a fiber-reinforced thermoset composite includes a die. A pulling device pulls a continuous material comprised of reinforcement fibers which are impregnated with a heat curable thermosetting resin through the die. A microwave generator is configured to subject a first portion of the continuous material, when the continuous material is pulled through the die, to a field of electromagnetic microwaves to heat the first portion to at least a curing temperature of the thermosetting resin. A controller is configured to control the microwave generator to reduce the field of electromagnetic microwaves such that a second portion of the continuous material is not heated to the curing temperature when the continuous material is pulled through the die.

The continuous material comprised of reinforcement fibers impregnated with the heat curable thermosetting resin may be provided in advance, or may be prepared just in time along with performing the method of the present disclosure. For example, the reinforcement fibers may be impregnated with the heat curable thermosetting resin before being drawn into the die or after being drawn by injecting the heat curable thermosetting resin into the die.

In the step of subjecting the first portion to the field of electromagnetic microwaves to heat the first portion according to the present disclosure, the continuous material is configured to be heatable by being subjected to the field of electromagnetic microwaves at least within the first portion. For example, the continuous material may, at least in the first portion, be configured with the reinforcement fibers including 30% or more of carbon fibers, and/or with the thermosetting resin including an admixture of an electrically conductive or a bipolar filler material such as carbon or iron powder.

As a result of performing the method of the present disclosure, since the first portion of the continuous material is heated to at least the curing temperature of the thermosetting resin, the first portion leaves the die in a permanently cured condition. On the other hand, the second portion is not heated to the curing temperature, and therefore leaves the die in an uncured condition, thus enabling it to be subsequently reshaped and cured to obtain a multi-curve shape as desired.

Because the heating of the first portion is effected by subjecting the first portion to the field of electromagnetic microwaves, heat is generated to cure the first portion within the first portion of the continuous material itself, in particular within the thermosetting resin comprised in the first portion. Thus, the die does not need to be heated in the present disclosure, and the die can be provided with a material that is not thermally affected by the field of electromagnetic microwaves.

Since the die does not need to be heated above the curing temperature for curing the first portion, there is no need to cool the die to below the curing temperature before the second portion is pulled through the die, which enables a low energy consumption to be achieved during manufacturing. Furthermore, since heating and cooling of the die are not necessary, a sharp transition between the cured condition of the first portion and the uncured condition of the second portion is possible even if the continuous material is pulled through the die at a high speed. Thus, a high manufacturing speed is achieved while manufacturing a highly accurate thermoset composite with the sharp transition between the cured first portion and the uncured second portion, such that subsequent reshaping and curing of the second portion to manufacture a highly precise multi-curve composite become possible.

According to the exemplary embodiment of the present disclosure, the sharp transition between the cured condition in the first portion and the uncured condition in the second portion of the continuous material is achieved, and thereby manufacturing a precise multi-curve shaped part using a thermoset composite. The termination of the field of electromagnetic microwaves can be simply achieved by using a switch, and the overall energy consumption for generating microwaves is reduced.

Further, simple and smooth manufacturing operations are possible while achieving a high manufacturing speed since the continuous material can be pulled through the die at a maximum speed for curing the first portion without slowing down.

In addition, a completely cured multi-curve particle is enabled directly result from carrying out the method. The second portion is heated by subjecting the second portion to a further field of electromagnetic microwaves. That is, the continuous material is configured within the second portion to be heatable by being subjected to the field of electromagnetic microwaves. For example, the continuous material may be configured with reinforcement fibers including 30% or more of carbon fibers, and/or with a thermosetting resin including an admixture of an electrically conductive or a bipolar filler material such as carbon or iron powder. In this way, the second portion can flexibly be reshaped, and the second portion is cured at a high speed with reduced energy consumption, thus achieving an improved manufacturing process. Furthermore, complex shapes can be achieved.

According to the exemplary embodiment of the present disclosure, the shape of the second portion can be modified by applying a reshaping process using a modifying control of the pulley movement, without having to provide a modified physical reshaping tool.

Further, according to the exemplary embodiment of the present disclosure a precise shaping is possible. More specifically, the stamping press can be moved with the continuous material. In this way, the continuous material does not have to be stopped during stamping, thus achieving higher manufacturing speeds.

Further, it is possible to achieve particularly complex shapes using the same reshaping tool by simply relocating the tool on the second portion during reshaping while curing the continuous material.

### BRIEF DESCRIPTION OF THE DRAWINGS

FIG. 1 is a schematic diagram of an apparatus for manufacturing a fiber-reinforced thermoset composite according to an embodiment of the present disclosure.

FIG. 2 is a schematic diagram of an apparatus for manufacturing a fiber-reinforced thermoset composite according to another embodiment of the present disclosure.

FIG. 3 is a face side view of a pultrusion die of FIGS. 1 and 2.

FIG. 4 is a cross sectional detail view along line A-A′ of a reshaping device of FIG. 2.

FIG. 5 is a flow chart of the method of manufacturing a fiber-reinforced thermoset composite according to the embodiment of the present disclosure.

Unless indicated otherwise, like reference numbers throughout the figures indicate like elements.

### DETAILED DESCRIPTION

Hereinafter, a method and an apparatus of manufacturing a fiber-reinforced thermoset composite according to embodiments of the present disclosure will be described with reference to the accompanying drawings.

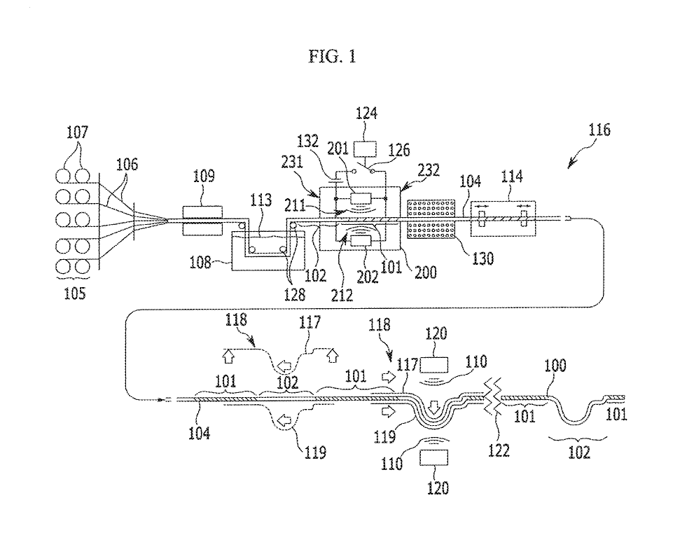

FIG. 1 schematically shows a manufacturing apparatus 116 for manufacturing a fiber-reinforced thermoset composite 100. The manufacturing apparatus 116 includes a fiber material storage device 105, in which reinforcement fibers 106 for the fiber-reinforced thermoset composite 100 are kept on respective spools 107. A drying device 109 dries the reinforcement fibers 106 received from the fiber material storage device 105. A resin tank 108 is filled with a liquid thermosetting resin 113 for impregnating the dried reinforcement fibers 106. Guide rolls 128 are arranged at the resin tank 108 for guiding the dried reinforcement fibers 106 through the resin tank 108. A pultrusion die 200 is arranged to receive a continuous material 104 comprised of the impregnated reinforcement fibers 106 which are guided from the resin tank 108 by the guide rolls 128. In alternative embodiments, the manufacturing apparatus may be configured to guide the reinforcement fibers 106 into the pultrusion die 200 in non-impregnated condition, and to inject the liquid thermosetting resin into the pultrusion die 200 in order to impregnate the reinforcement fibers 106 within the pultrusion die 200.

In the present disclosure, the continuous material 104 may be configured to be heatable by being subjected to a field of electromagnetic microwaves. For example, the reinforcement fibers may include 30% or more of carbon fibers, or the thermosetting resin may include an admixture of an electrically conductive or a bipolar filler material such as carbon or iron powder.

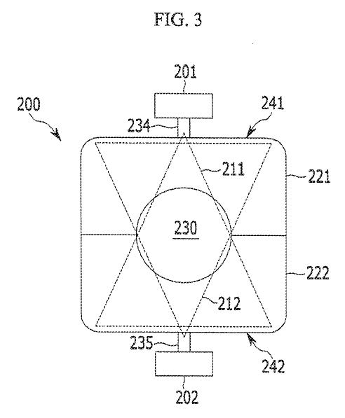

Hereinafter, the configuration of the pultrusion die 200 will be explained in more detail with further reference to FIG. 3. FIG. 3 shows the pultrusion die 200 from any one of die entrance and exit face sides 231 and 232, i.e. a view along the die entrance face side 231 to the exit face side 232. The continuous material 104 is guided through the pultrusion die 200 and extends through the pultrusion die 200 from the die entrance face side 231 to the die exit face side 232. The continuous material 104 enters and fills out a die opening 230 shown in FIG. 1, whereas, the pultrusion die 200 in FIG. 3 is empty. Here, the die entrance and exit face sides 231, 232 are symmetrical and identical, and the die opening 230 has a circular cross section and extends from the die entrance face side 231 to the die exit face side 232 in a straight line. The pultrusion die 200 comprises an upper die half 221 and a lower die half 222, which are symmetrically shaped and stacked on top of each other to have the cylindrically-shaped die opening 230 between them. The die opening 230 according to the present disclosure comprises the circular cross section by way of example, however, alternative embodiments may comprise different cross-sectional shapes.

The pultrusion die 200 is equipped with first and second microwave generators 201, 202 for subjecting a portion of continuous material 104, which enters the die opening 230, to fields of electromagnetic microwaves 211, 212 in order to heat the portion of continuous material 104 to at least a curing temperature of the thermosetting resin 113. The first microwave generator 201 is externally mounted to the upper die half 221 with a first waveguide 234 at a top face 241 of the upper die half 221. Similarly, at a bottom face 242 of the lower die half 222, the second microwave generator 202 is externally mounted to the lower die half 222 with a second waveguide 235, which is vertically below the first microwave generator 202. Both die halves 221, 222 are made of a material that is substantially permeable to microwave frequency electromagnetic fields such as a ceramic material.

The first microwave generator 201 is configured to generate a first field of electromagnetic microwaves 211 which fills a cone-shaped region extending from a cone vertex at the top face 241 to a cone base at the bottom face 242 within the pultrusion die 200. Similarly, the second microwave generator 202 is configured to generate a second field of electromagnetic microwaves 212 which fill a cone-shaped region extending from a cone vertex at the bottom face 242 to a cone base at the top face 241 within the pultrusion die 200. Both first and second fields of electromagnetic microwaves 211, 212 overlap in the die opening 230, such that during activation of the microwave generators 201, 202, the die opening 230 is filled by a substantially homogeneous microwave field having sufficient strength to heat the portion of the continuous material 104 that is located inside the die opening 230 to above the curing temperature within a longitudinally extending microwave irradiation zone.

In FIG. 1, the first and second microwave generators 201, 202 are disposed inside the pultrusion die 200. While the microwave generators of the present disclosure are externally mounted as described above, in alternative embodiments, the microwave generators 201, 202 may also be arranged anywhere within the pultrusion die 200. Furthermore, the number of microwave generators is not limited to two but may be any number as long as the microwave generators are configured to irradiate in a microwave irradiation zone within the die opening 230 with a field of electromagnetic microwaves having sufficient strength.

The manufacturing apparatus 116 further comprises a cooling device 130 for cooling the continuous material 104 to room temperature after receiving the continuous material 104 from the pultrusion die 200, which is heated in the pultrusion die 200. The cooling device 130 prevents heat spreading out from the portion of the continuous material 104, which is heated in the pultrusion die 200, to the neighboring portion of the continuous material 104. Thus, a boundary between cured portions and uncured portions is defined in the continuous material 104.

Furthermore, the manufacturing apparatus 116 comprises a pulling device 114 for continuously pulling the continuous material 104 formed of the reinforcement fibers 106 impregnated with resin 113 through the drying device 109, the resin tank 108, the pultrusion die 200, and the a cooling device 130, thereby driving the preparation process for the continuous material 104.

The manufacturing apparatus 116 further comprises a power source 132 for supplying electric power to the first and second microwave generators 201, 202, as well as a switch 126 for connecting and disconnecting the power source 132 with the first and second microwave generators 201, 202. In addition, a controller 124 is provided for controlling the switch 126. The controller 124 is configured to control the first and second microwave generators 201, 202 by switching the switch 126 on and off at regular intervals, in coordination with the pulling of the continuous material 104 by the pulling device 114, thereby providing alternating portions in the continuous material 104. Cured first portions 101 of the continuous material 104 alternate with uncured second portions 102 of the continuous material 104, each having a predetermined length controlled by the controller 124.

The manufacturing apparatus 116 further includes a reshaping device 118 for reshaping the uncured second portions 102 of the continuous material 104, a heating device 120 for heating the reshaped second portions 102 to at least the curing temperature of the thermosetting resin, and a cutting device 122 for cutting the continuous material 104 into separate fiber-reinforced thermoset composites 100. For convenience of display, these components 118, 120, 122 are shown in the bottom half of FIG. 1 but may be arranged next to the pulling device 114 to be in line with the preceding components 107, 109, 108, 200, 130, 114 of the manufacturing apparatus 116. Further transportation devices (not shown) may be provided as needed for transporting the continuous material 104 beyond the pulling device 114.

The reshaping device 118 includes a stamping press comprising a stamp 117 and a correspondingly shaped stamping form 119. The reshaping device 118 is shown in FIG. 1 in an open position (dotted lines) in which the stamp 117 is positioned above the uncured second portion 102 of the continuous material, with the stamping form 119 positioned underneath. Furthermore the reshaping device 118 is positioned in a closed position (solid lines) in which the stamp 117 presses into the stamping form 119, thereby shaping the uncured second portion 102 according to the corresponding shapes of the stamp 117 and stamping form 119. Since the continuous material 104 cannot be stretched or elongated due to the presence of the reinforcement fibers 106, length of the reshaped second portion 102 is the same as the length of the uncured second portion 102 before reshaping. The heating device 120 is implemented by two further microwave generators to generate a further field of electromagnetic microwaves 110 for heating the thermosetting resin comprised in the reshaped second portion 102 to at least the curing temperature.

The reshaping device 118 is configured to move along the continuous material 104. In the operation, a reshaping controller that may be part of the controller 124 described above controls the reshaping device 118 to first assume the open position (dotted lines). When the uncured second portion 102 passes between the stamp 117 and stamping form 119, the stamp 117 is controlled to gradually move toward the stamping form 119 while both the stamp 117 and the stamping form 119 are controlled to simultaneously move together with the continuous material 104 in the same direction and at the same speed as the continuous material 104 itself. In this way, the reshaping device 118 gradually reshapes the second portion 102 while traveling together with the same until the closed position of the reshaping device 118 (solid lines) is reached. The heating device 120 is fixedly arranged at the closed position of the reshaping device 118 (solid lines).

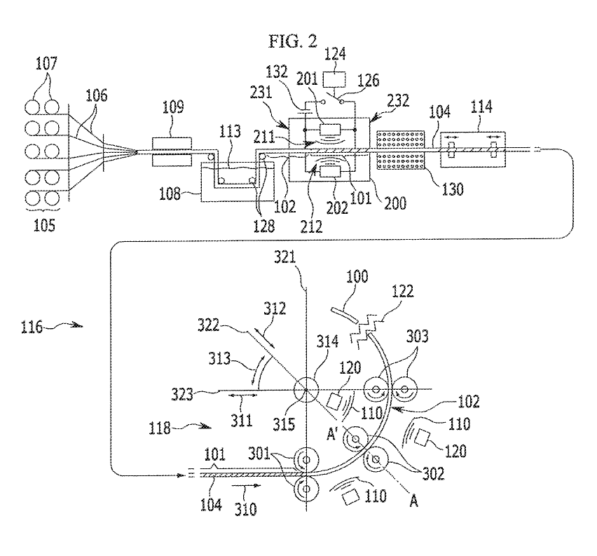

FIG. 2 is a schematic diagram of a manufacturing apparatus 116 for manufacturing a fiber-reinforced thermoset composite 100 according to another embodiment. As for the embodiment of FIG. 1, the manufacturing apparatus 116 according to an exemplary embodiment of the present disclosure is divided into an upper and a lower part for convenience of display only. The arrangement of components 107, 109, 108, 200, 130, 114 displayed in the upper part of FIG. 2 are identical to the components displayed in the upper part of FIG. 1. In other words, the manufacturing apparatus 116 of the embodiment of FIG. 1 is different from the embodiment of FIG. 2 only with respect to the components displayed in the lower half of FIG. 2.

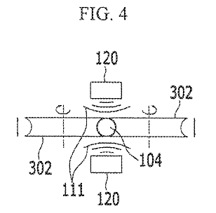

The reshaping device 118 of the manufacturing apparatus 116 of the present disclosure includes three pairs of pulleys 301-303. As can be seen in an additional detailed view given in FIG. 4, each pulley 301-303 has an identical cross section with a periphery shaped according to the cross section of the continuous material 104, in such a way that each pair of the pulleys 301-303 is able to accommodate the continuous material 104 between the two individual pulleys of the respective pair, as is illustrated for one pair of pulleys 302 in FIG. 4. Each of the three pairs of pulleys 301-303 is rotatably mounted on a respective pulley arm 321-323 comprised by the reshaping device 118. The pulley arms 321-323 are held in a common moving device 314, which is adapted both to hold the pulley arms 321-323 and to move at least a subset thereof for moving the corresponding pairs of pulleys.

A first pulley arm 321 of the three pulley arms 321-323, which bears a first pair of pulleys 301 of the three pairs 301, 302, 303, is fixed by the moving device 314. A second pulley arm 322 of the three pulley arms 321-323, which bears a second pair of pulleys 302 of the three pairs 301-303, is held by the moving device 314 such as to be protractible and retractable in a further reshaping direction 312 that is perpendicular to the longitudinal direction 310 of the continuous material 104, and additionally to be rotatable in a rotational direction 313 around a rotation center 315 located in the moving device 314. A third pulley arm 323 of the three pulley arms 321, 322, 323, which bears a third pair of pulleys 303 of the three pairs 301-303, is held by the moving device 314 such as to be protractible and retractable in a reshaping direction 311 that is perpendicular to a longitudinal direction 310 of the continuous material 104.

The heating device 120 of the manufacturing apparatus 116 of the present disclosure is, as shown in FIG. 1, provided as further microwave generators for subjecting the uncured second portion 102 of the continuous material 104 with the field of microwaves 110 in order to heat them to at least the curing temperature. As can be seen in FIG. 4, the heating device 120 of the present embodiment also includes microwave generators located beyond FIG. 2.

In the operation, the moving device 314 is controlled by a controller (not shown), which may be implemented by the controller 124 shown in FIG. 2, to move the second pair of pulleys 302 and the third pair of pulleys 303 to reshape the uncured second portion 102 of the continuous material 104 into a desired shape. Unlike the embodiment of FIG. 1, the heating device 120 in FIG. 2 is configured to heat the second portion 102 of the continuous material 104 while the second portion 102 is being reshaped by the reshaping device 118. In this way, a continuous reshaping process is carried out simultaneously with a heating process for curing the thermosetting resin in the same second portion 102.

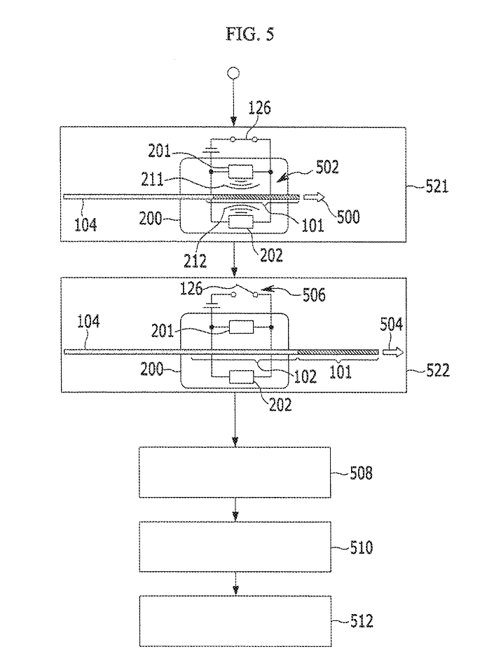

A method of manufacturing a fiber-reinforced thermoset composite by the embodiment of FIG. 1 or the embodiment of FIG. 2 will now be described with reference to a flow chart illustrated in FIG. 5.

In the first phase 521, steps 500, 502 are performed. In step 500, the first portion 101 of the continuous material 104 comprised of the reinforcement fibers 106 which are impregnated with a heat curable thermosetting resin is pulled through the pultrusion die 200. The continuous material 104 is configured to be heatable by being subjected to a field of electromagnetic microwaves, e.g. by including an appropriate amount of electrically conductive reinforcement fibers or/and including an appropriate amount of electrically conductive or bipolar filler material in the thermosetting resin. Step 502 is carried out concurrently with step 500 as a part of the first phase 521, the first portion 101 is subjected in the pultrusion die 200 to the fields of electromagnetic microwaves 211, 212 to heat the first portion 101 to at least a curing temperature of the thermosetting resin.

Next, a second phase 522 is performed which includes carrying out two steps 504, 506. In step 506, the fields of electromagnetic microwaves 211, 212 used in step 502 of the first phase 521 is switched off. Then, in step 504, the second portion 102 of the continuous material 104 is being pulled through the pultrusion die 200, Because the fields of electromagnetic microwaves 211, 212 have been switched off, the second portion 102 is not heated to the curing temperature, which is different from the first portion 101 in step 502 of the first phase 521.

Subsequently, in step 508, the second portion 102 of the continuous material 104 is reshaped. In step 510, the second portion 102 is heated to at least the curing temperature of the thermosetting resin. In alternative embodiments, steps 508 and 510 may also be performed simultaneously. After the second portion 102 has been cured, the fiber-reinforced thermoset composite that includes both the first portion 101 and the second portion 102 is removed from the remaining continuous material 104.

The method as described with reference to FIG. 5 may be performed continuously, e.g. such that step 500 of pulling the first portion 101 through the pultrusion die 200 and step 504 of pulling the second portion 102 through the pultrusion die 200 are performed by one continuous pulling action on the continuous material 104.

Furthermore, such continuous pulling action on the continuous material 104 may continue after step 504 after the second portion 102 leaves the pultrusion die 200. In this way, while performing steps 508-510 for the first and second portions 101,102 as described above, a next process using the method as described above may be started, in order to produce a further fiber-reinforced thermoset composite. According to the method of the present disclosure, a sequential manufacturing of fiber-reinforced thermoset composites is possible.

What is claimed is:

1. A method of manufacturing a fiber-reinforced thermoset composite, comprising steps of:
pulling a first portion of a continuous material comprised of reinforcement fibers which are impregnated with a heat curable thermosetting resin through a die;
subjecting the first portion in the die to a field of electromagnetic microwaves to heat the first portion to at least a curing temperature of the thermosetting resin;
pulling a second portion of the continuous material through the die; and
reducing the field of the electromagnetic microwaves in the die such that the second portion is not heated to the curing temperature.

2. The method according to claim 1, wherein the field of the electromagnetic microwaves is terminated in the step of reducing the field of electromagnetic microwaves.

3. The method according to claim 2, wherein the step of pulling the first portion and the step of pulling the second portion are performed by continuously pulling the continuous material through the die.

4. The method according to claim 1, further comprising steps of:
reshaping the second portion of the continuous material; and
heating the second portion to at least the curing temperature of the thermosetting resin.

5. The method according to claim 4, wherein the step of heating the second portion is performed by subjecting the second portion to a further field of electromagnetic microwaves.

5. The method according to claim 5, wherein the step of reshaping is performed continuously.

7. The method according to claim 4, wherein the step of reshaping includes:
guiding the continuous material between a plurality of pulleys; and
moving at least one of the pulleys in a reshaping direction perpendicular to a longitudinal direction of the continuous material.

8. The method according to claim 4, wherein the step of heating the second portion is performed concurrently with the step of reshaping the second portion.

9. The method according to claim 1, wherein the step of pulling the first portion and the step of pulling the second portion are performed by continuously pulling the continuous material through the die.

10. The method according to claim 4, wherein the step of reshaping is performed continuously.

11. An apparatus or manufacturing a fiber-reinforced thermoset composite, comprising:
a die;
a puffing device configured to pull a continuous material comprised of reinforcement fibers which are impregnated with a heat curable thermosetting resin through the die;
a microwave generator configured to subject a first portion of the continuous material to a field of electromagnetic microwaves to heat the first portion to at least a curing temperature of the thermosetting resin when the first portion is pulled through the die;
a controller configured to control the microwave generator to reduce the field of electromagnetic microwaves such that a second portion of the continuous material is not heated to the curing temperature when the second portion is pulled through the die.

12. The apparatus according to claim 11, further comprising:
a reshaping device for reshaping the second portion; and
a heating device for heating the second portion to at least the curing temperature of the thermosetting resin.

13. The apparatus according to claim 12, wherein the heating device includes a further microwave generator for heating the second portion of the continuous material.

14. The apparatus according to claim 12, wherein the reshaping device includes:
a plurality of pulleys for guiding the continuous material; and
a moving device for moving at least one of the pulleys in a reshaping direction which is perpendicular to a longitudinal direction of the continuous material.
